(19) United States
(12) Patent Application Publication
(10) Pub. No.: US 2004/0083116 A1
(43) Pub. Date: Apr. 29, 2004

(54) Methods for identifying or predicting capacity problems

(76) Inventor: Derek J. Joyce, London (GB)

Correspondence Address: LOWENSTEIN SANDLER PC, 65 LIVINGSTON AVENUE, ROSELAND, NJ, 07068, US

(21) Appl. No.: 10/345,850

(22) Filed: Jan. 16, 2003

Related U.S. Application Data
(60) Provisional application No. 60/421,452, filed on Oct. 25, 2002.

(51) Int. Cl. G06F 17/60

(52) U.S. Cl. 705/1

(57) ABSTRACT

Methods to identify and predict capacity problems in systems. The methods of the invention involve identifying, defining, and separating: (1) the set of internal capacity parameters, (2) the set of external capacity parameters, and (3) key performance indicators, for system administrator analysis. Such separation of these sets of variables and parameters followed by their presentation in a data-management framework, greatly enhances the capability of a system administrator to detect and predict capacity problems.

This application claims the benefit of U.S. Provisional Application No. 60/421,452 filed Oct. 25, 2002, which application is hereby incorporated herein by reference.

### 1. FIELD

The invention relates to methods for identifying or predicting capacity problems in systems. Such methods are particularly useful to aid system administrators in managing the capacity of complex systems.

### 2. BACKGROUND

Methods for identifying or predicting capacity problems are highly important in a wide variety of systems, such as data-processing systems used in complex financial transactions, Internet commerce, manufacturing, distribution, networking, and many others. Such systems have finite resources and typically operate subject to a variety of constraints that may challenge or, upon occasion, even exceed system capacity with deleterious results. For example, business entities, such as financial institutions, generally run a multitude of complex computer-software applications concurrently, at overlapping intervals, and/or at spaced intervals on systems of finite computing resources. Many of these applications output time-sensitive information that must be acquired prior to a deadline. For example, a financial institution might require certain crucial pricing information in connection with certain financial instruments before the morning opening of the trading market. For complex financial instruments, obtaining such pricing information might require eight or more hours of computer processing. Since the computer system has only the time between the previous day's market close and the morning opening to output the new pricing information, capacity management is crucial; lest deadlines be missed. Accordingly, it is crucial that such entities be able to manage computing resources.

The necessity of efficient system-capacity management is much broader than the computer-system example above. There are similar concerns with many other systems and subsystems, for example, internet buying and selling platforms, manufacturing assembly lines, product-distribution systems, document archiving, highway systems, library cataloging, and supermarket-shelf stocking, etc.

Such systems, such as software-application systems, have particular associated capacity variables, for example, the number of users, executions per user, the complexity or amount of data, and/or the complexity of the algorithms run by the application. Many of these capacity variables change over time, for example, the number of users may increase, the algorithm may be modified as the analysis increases in complexity. Accordingly, to avoid impending system failures and unsatisfied deadlines, it is important to manage computer resources and application scheduling based on projected growth in capacity variables.

Generally, system administrators manage system capacity in an unorganized fashion, without classification or differentiation of capacity variables, typically based on experience, system knowledge, instinct, and even trial and error. As such, capacity problems are often not identified until it is too late. These methods are not satisfactory in cases where system failure and missed deadlines are unacceptable.

Reliable, accurate, generally applicable, and organized methods are needed for identification and forecasting of system-capacity problems to aid capacity management. Such methods are needed to prevent system overload and/or failure to avoid unacceptable outcomes, such as unsatisfied deadlines.

### 3. SUMMARY OF THE INVENTION

The invention is directed to generally applicable methods for detecting and forecasting capacity problems in systems. A system is any series of steps for performing a process and the architecture, hardware, and/or equipment for performing the steps. The methods of the invention alert the system administrator to a problem or potential problem so that the appropriate action can be taken. Capacity means the system resources available to one or more processes. A process will utilize a certain amount of available resources at a given time. If a process exceeds its available resources, performance will be adversely affected. Performance includes things like efficiency, accuracy, cost effectiveness, and reliability.

Using the methods of the invention, system capacity problems can be pinpointed much more efficiently and accurately. Once they are identified, corrections and adjustments can be made as appropriate. In general, the invention is suitable for use with any complex process or system, for example, computer-network applications systems, internet buying and selling platforms, manufacturing assembly lines, product-distribution systems, document archiving, highway systems, library cataloging, even supermarket capacity management.

### 4. BRIEF DESCRIPTION OF THE FIGURES

These and other features, aspects, and advantages of the present invention will become better understood by considering the accompanying drawing where:

FIG. 1 is a flow chart outlining the steps of one embodiment of the invention.

### 5. DETAILED DESCRIPTION

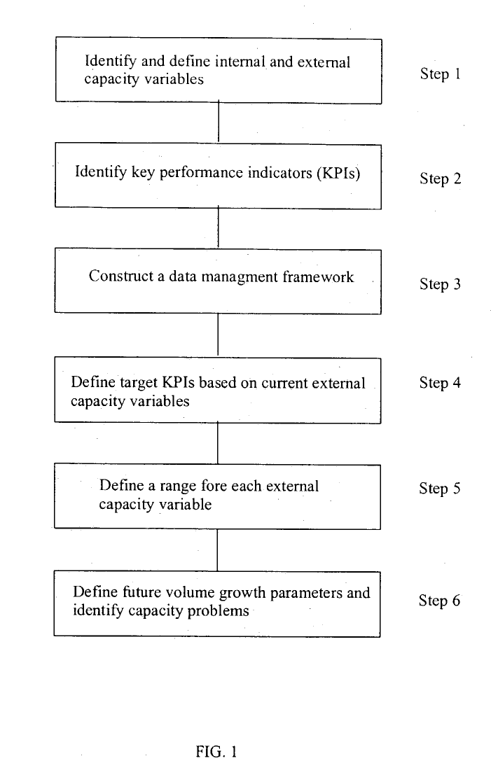

Referring to the drawing, FIG. 1 is a schematic flow chart illustrating the steps involved in an exemplary method of the invention for identifying or predicting capacity problems. In an advantageous embodiment, the invention comprises the following set of steps to identify and forecast capacity problems. Step 1, is to identify, define, and separate internal and external capacity variables. Step 2 is to identify key performance indicators (KPIs). Step 3 is to construct a data-management framework, wherein the set of internal capacity variables, the set of external capacity variables, and the set of KPIs are separately presented or displayed. Step 4 is to define target KPIs based on current external variables. Step 5 is to define a range for each external capacity variable. And step 6 is to define future-volume-growth parameters and identify and forecast capacity problems. Each of these steps is described in more detail in the following Description and Example.

### 5.1 Identifying and Defining Capacity Variables and Key Performance Indicators

### 5.1.1 Identification of Capacity Variables

In step 1, “capacity variables” are identified. As used herein, “capacity variables” include any variable that affects the capacity of a system or performance of a process.

One of skill in the art can readily identify and assign capacity variables for use in the methods of the invention depending on the process, the system, and the constraints. According to the invention, variables that affect capacity are categorized in two general types: (1) internal capacity variables; and (2) external capacity variables.

Internal capacity variables are capacity variables that are particular to the nature and structure of the system and process. Generally, the system administrator has control over internal capacity variables. External capacity variables are capacity variables that are determined independently of the system's structure, such as volume inputs. Generally, external capacity variables are beyond the system administrator's control.

For example, in a system comprising a computer network simultaneously running a plurality of computer-software applications that access and process data, internal capacity variables include, but are not limited to, the number and complexity of applications; the connection speed by which the data can be accessed or downloaded; and the computing power available.

External capacity variables for such a system include, but are not limited to, deadlines by which one or more of the applications must complete data processing; the complexity of the analysis undertaken by each application; the amount and nature of data presented to each application for processing; the number of users that will operate a particular application; the number of transactions that an average user will execute on a particular application; and the time a user is willing to wait for each execution.

A specific example of such a system is a computer network that runs a pricing-engine application that calculates the value of equity derivatives. Internal capacity variables include, but are not limited to, the number of central processing units available to the application; the computing power of the central processing units; the complexity of the derivatives to be valued, such as the number and type of underlying securities; the sophistication of the pricing engine application, for example, the complexity of the model chosen to value the derivatives; the accessibility of the data that must be processed; and the programming efficiency of the software application.

External capacity variables of such a system include, but are not limited to, the deadline by which the derivatives must be valued, which is before the market opens the next day; the time in which the application has to run, which is between the securities market's evening close and the opening of the market the following morning; and the number of derivatives, as a result of investor demand, that must be valued.

In a system comprising a production line for painting car doors, internal capacity variables include, but are not limited to, the number of workers in the line; equipment-automation speed (rate of paint output by a sprayer or conveyer-belt speed); the number of hours workers are allowed to work; overtime available; and the number of breaks allowed to workers. As is apparent, many of these variables are interrelated.

External capacity variable for such a system would include, but are not limited to, the number of car doors presented to the production line for processing, for example, as a result of the economic car-door demand or forecasted economic car-door demand; the paint type consumers want, for example consumers might want a difficult-to-apply metallic paint, a paint that takes a long time to dry, or a paint that requires extra buffing; the size and complexity of car doors auto manufactures are demanding, for example, designs that have many nooks and crannies; the rate at which cars having the car doors are sold by dealers, which affects demand for car doors; changes in shipping rates; and cost of paint and other raw materials.

### 5.1.2 Identification of Key Performance Indicators (“KPI”)

Next, “key performance indicators” are identified. As used herein, the phrase “key performance indicator” or “KPI” means a variable corresponding to the result or outcome of a process, wherein the result or outcome provides information regarding how well or poorly a system or process is operating. Generally, such a result or an outcome, to a greater or lesser extent, depends upon the capacity variables. KPIs include, but are not limited to, parameter, rate, and measure variables such as, the time taken by a system to complete a process or a portion of a process; the rate that the system outputs its product; the volume the system is handling; errors or defects per unit time; the number of transactions or cycles per unit time; and the cost to run the system or process. One of skill in the art can readily identify appropriate KPIs for use in the invention depending on the system, the process, and the desired results.

For a system comprising a computer network simultaneously running a plurality of computer-software applications that access and process data, examples of KPIs include, but are not limited to, the rate of execution of a particular routine that significantly affects computing-resource capacity; the speed at which the data is accessed and downloaded; the percentage of computing power utilized; whether deadlines are being met; and the time taken for each cycle or execution.

In the specific example given above of a computer network that runs a pricing-engine application that calculates the value of equity derivatives, examples of KPIs include, but are not limited to, the rate at which equity derivatives are valued; the percentage of total computing power utilized by the application at a given time; the number of other applications simultaneously running on the same system; the rate at which the data is processed; whether the derivatives are valued by the deadline; and the time at which processing is completed.

In a system comprising a production line for painting car doors, KPIs include, but are not limited to, the number of defects per unit time; the number of defects as a percentage of car doors painted; the number of car doors painted per unit time; the number of overtime hours workers elect; and the number of car doors fed into the production line per unit time.

### 5.2 Construction of a Data-Management Framework

In Step 3, a data-management framework is constructed such that the set of internal capacity variables, the set of external capacity variables, are separately displayed or set forth. The data management framework may further set forth the set of KPIs. A data-management framework can be any hard-copy spreadsheet or computer database or other display that effectively presents the set of internal capacity variables, the set of external capacity variables, and the set of KPIs as three separate categories for the system administrator's analysis. This requires defining and implementing a data-gathering method by well-known methods.

### 5.3 Defining Targe KPIs

In Step 4, the system administrator determines performance expectations by setting values for KPIs based on expectations from system users and other measures and variables that affect whether expectations are achieved. These values are called target KPIs. For example, a target KPI may depend on external capacity variables, such as the current volume of products or transactions the end user wants and the time in which they want them. The system administrator will determine an appropriate buffer between the target KPI and the expectations to be achieved. In other words, the target KPI will be adjusted from the minimum KPI required to achieve expectations.

Under the facts of the pricing-engine example above, say that, according to standard methods, the system administrator determines that under current investor demand (which is an external capacity variable) that 20,000 derivatives must be valued each day, before the market opening. Then, by applying well-known analytical methods to the data-management framework of the invention, the system administrator can determine that at least an average valuation rate of 0.2 seconds per derivative is required to meet a 7:00 AM deadline. This is the minimum value of the KPI required to meet the deadline. The system administrator would include an appropriate buffer by setting the target KPI at a somewhat lower value, e.g., 0.19 seconds per derivative.

In the system outlined above comprising a production line for painting car doors, the system administrator may determine, based on the volume of painted car doors ordered by auto manufacturers (external capacity variable) that forty car doors must be painted a day and that less than five percent of the forty car doors should have defects serious enough to require repaint. Thus, the target KPI is forty car doors painted per day with at least thirty-eight defect free.

### 5.4 Defining the Range for Each External Capacity Variable within which the System can Achieve the Target KPI

In this step, the system administrator defines a range for each of the identified external capacity parameters that the system can handle and still achieve the target KPIs determined in Section 5.3 above (“external-capacity-variable range”). The assumption is that the internal capacity variables remain the same. If they have changed, one of skill in the art can readily modify the procedure below as appropriate.

Defining an external-capacity-variable range for each external capacity variable is accomplished through a review of the data-management framework prepared according to Section 5.2 above, particularly, defining relationships between internal and external capacity variables and KPIs. This can be accomplished by well-known methods. In other words, based on his experience and the system constraints set by the internal capacity variables, the administrator can define a range for each external capacity variable that the system can accommodate and still achieve the target KPI. A continuing feed of KPIs as the system is running and historic data on the system's operation is helpful.

Because the data-management framework of the invention sets forth the set of internal capacity variables, the set of external capacity variables, and the set of KPIs as three separate categories, this analysis is simplified over and results in more accurate results than prior art methods.

Consider the specific example set forth above of a computer network that runs a pricing-engine application. The system administrator may determine, based on analysis of the data-management framework according to the methods of the invention, that 40,000 derivatives can be valued within eight hours pushing the computer network system to its limits. The system administrator has also determined in Section 5.3 above, that at least 20,000 derivatives must be valued within eight hours. Thus, the external-capacity-variable range is 20,000 to 40,000 derivatives within the eight-hour time-frame constraint.

In the system outlined above comprising a production line for painting car doors, the system administrator may determine, based on the internal capacity variables, that by pushing the workers to their limits and limiting their break time, the production-line system can output eighty car doors a day with a ten percent defect rate. The system administrator has determined in Section 5.3 above that, to meet current end-user demand, forty car doors must be painted a day with less than five percent defect rate. Thus, the external-capacity-variable range is forty to eighty painted car doors per day with a five to ten percent defect rate.

### 5.5 Defining Future Growth Parameters and Identifying Capacity Problems

This step equips the system administrator to identify capacity problems. The system administrator compiles the data from above steps 1-5 to generate day-to-day reports and historic data. Next, the system administrator predicts future volume growth by well-known methods, such as analyzing trends and getting feedback from system users. The future-volume growth is mapped and translated into predicted external capacity parameters by well-known methods. By comparing the data obtained from steps 1-5 above with future volume growth and predicted external capacity variables, the system administrator is equipped to determine capacity problems.

In the example of a computer network that runs a pricing-engine application, which calculates the value of equity derivatives, the system administrator-may determine, based on his experience, trends in the market, economic forecasts, political commentary, and other economic indicators that in one year, investor demand will be such that his pricing-engine system will need to value 45,000 derivatives a day. Even more, the system administrator determines that twenty five percent of these derivatives will be of higher complexity than those currently valued.

Considering that from his analysis of the data-management framework for this system according to the methods of the invention in Section 5.4—the system can only handle 40,000 derivatives at peak operation, the system administrator realizes that he has a capacity problem. He can address capacity issues in a number of ways well known to those of skill in the art, for example, increasing computing resources, increasing the software efficiency, or improving the pricing model.

In the system outlined above comprising a production line for painting car doors, the system administrator may determine, based on sales trends reported by car salespersons that by the end of the fiscal year, he must paint sixty car doors per day, with a 12% defect rate. Since, at maximum capacity, his production line system can handle eighty car doors per day with a 10% defect rate, the system administrator determines that the there is no imminent capacity problem, and the status quo can be maintained.

It can now be seen that the invention includes a method for identifying or predicting capacity problems in a system comprising:

(a) identifying at least one internal capacity variable for the system;

(b) identifying at least one external capacity variable for the system;

(c) identifying at least one key performance indicator for the system;

(d) constructing a data-management framework comprising and separately setting forth:

(i) the internal capacity variable, and

(ii) the external capacity variable;

(e) defining at least one target key performance indicator;

(f) defining at least one external-capacity-variable range for the external capacity variable;

(g) defining at least one future growth parameter for the external capacity variable; and

(h) analyzing the future growth parameter and the external-capacity-variable range in view of the data-management framework to identify the capacity problem.

Although the present invention has been described in considerable detail with reference to certain preferred embodiments and versions, other versions and embodiments are possible. Therefore, the scope of the appended claims should not be limited to the description of the versions and embodiments expressly disclosed herein.

What is claimed is:

1. A method for identifying or predicting capacity problems in a system comprising:
(a) identifying at least one internal capacity variable for the system;
(b) identifying at least one external capacity variable for the system;
(c) identifying at least one key performance indicator for the system;
(d) constructing a data-management framework comprising and separately setting forth:
(i) the internal capacity variable, and
(ii) the external capacity variable;
(e) defining at least one target key performance indicator;
(f) defining at least one external-capacity-variable range for the external capacity variable;
(g) defining at least one future growth parameter for the external capacity variable; and
(h) analyzing the future growth parameter and the external-capacity-variable range in view of the data-management framework to identify the capacity problem.

2. The method of claim 1, wherein the key performance indicator relates to a parameter, or a rate.

3. The method of claim 2, wherein the parameter or the rate comprises a time taken by the system to complete a process or a portion thereof; a volume the system is handling; a cost to run the system or process; errors or defects per unit time; or transactions or cycles per unit time.

4. The method of claim 1, wherein the data-management framework is stored in a computer-readable medium.

5. The method of claim 1, wherein the data-management framework is stored in random access memory.

6. The method of claim 1, wherein the system comprises computer resources, for use by one or more users, comprising random access memory and one or more computer processors programmed with one or more computer software applications.

7. The method of claim 6, wherein the internal capacity variable relates to:
(a) a number of the software applications,
(b) a complexity of one or more of the software applications,
(c) a speed at which data can be accessed or downloaded
(d) a speed at which data can be processed by one or more of the computer software applications, or
(e) an amount of the computer resources available.

8. The method of claim 6, wherein the external capacity variable relates to:
(a) a time deadline;
(b) complexity of an analysis;
(c) an amount or nature of data;
(d) a number of users; or
(e) a time one or more users will wait.

9. The method of claim 6, wherein the key performance indicator relates to usage of available computer resources.

10. The method of claim 6, wherein one or more of the software applications is designed to capture trades; execute trades; price financial instruments; manage risk; calculate position; calculate profit or loss; process financial-instrument transaction settlements, process financial-instrument transaction confirmations, process and reconciliate financial accounts, or provide internal and client reporting.

11. The method of claim 6, wherein the computer resources are subject to the control of a system administrator and wherein the internal capacity variable is within the control of a system administrator.

12. The method of claim 11, wherein the internal capacity variable relates to:
(a) a number of the software applications,
(b) complexity of one or more of the software applications,
(c) a speed at which data can be accessed or downloaded
(d) a speed at which data can be processed by one or more of the computer software applications, or
(e) an amount of the computer resources available.

13. The method of claim 6, wherein the external capacity variable is outside the control of the system administrator.

14. The method of claim 13, wherein the external capacity variable relates to:
(a) a time deadline;
(b) complexity of an analysis;
(c) an amount or nature of data;
(d) a number of users; or
(e) a time one or more users will wait.

15. The method of claim 6, wherein one or more of the computer software applications is designed to process financial data.

16. The method of claim 15, wherein the financial data relates to one or more financial instruments.

17. The method of claim 16, wherein one or more of the financial instruments is an equity, equity derivative, bond, interest-rate derivative, currency, currency derivative, commodities contract, future, option, swap, or credit derivative.
